(19) United States
(12) Patent Application Publication
(10) Pub. No.: US 2006/0054772 A1
(43) Pub. Date: Mar. 16, 2006

(54) Accessory for supporting a shading device

(76) Inventors: Chris Priscott, Queensland (AU); Craig Warren, Queensland (AU)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 10/476,807

(22) PCT Filed: May 7, 2002
(86) PCT No.: PCT/AU02/00562

§ 371 Date: Jun. 27, 2005

(30) Foreign Application Priority Data
May 4, 2001 (AU) PR 4808
Jul. 12, 2001 (AU) PR 6353
Oct. 8, 2001 (AU) PR 8136
Jan. 25, 2002 (AU) 2002100057

(51) Int. Cl. F16M 13/00

(52) U.S. Cl. 248/558; 248/518; 135/44

(57) ABSTRACT

An accessories (2) for hands-free support of a shading device (1) with respect to a ground surface (3) by a ground stake (5) or objects such as a picnic table (4), railing or the like by a clamp (14). The accessory (2) comprises complementary components (7, 20) connected by a ball joint to permit movement between the components.

### TECHNICAL FIELD

This invention relates to supports for shading devices such as umbrellas used by sportsmen, sports spectators and for general purposes.

### BACKGROUND ART

Various proposals to enhance the useability of umbrellas for sports people and others have been proposed in the past.

Some of these proposals have embodied the concept of extending the length of the handle of an umbrella to enable it to be freestanding.

Such a concept is especially attractive to open space sports people such as golfers who on many occasions would like to have the benefit of the protection offered by an umbrella on a hands-free basis so that activities such as scoring, glove changing, taking refreshments and the like can be carried out under the protection of an umbrella.

U.S. Pat. Nos. 5,749,386, 5,293,889 and 4,733,681 are examples of enhancements to umbrellas for various purposes.

Some of these patents describe telescopic extensions from the handle of an umbrella whilst others describe sectional or add-on extensions to the handles of umbrellas.

Bearing in mind that most sports umbrellas are sold at a relatively modest price (often subsidised by advertising) any proposals which substantially increase the price of these items are likely to be resisted by the intended users.

It is accordingly an object of the present invention to provide an umbrella accessory which will enhance the useability of umbrellas which can be provided at a relatively modest price.

Further objects and advantages of the present invention will become apparent from the ensuing description which is given by way of example.

### DISCLOSURE OF INVENTION

According to the present invention, there is provided an accessory for facilitating the hands-free support of a shading device, the accessory comprising;
(a) a female member,
(b) a male member attachable to the female member, and
(c) a support, characterised in that the female member is embodied within or attachable to a handle of a shading device and the male member is embodied with or attachable to the support.

The support can be a ground stake and include the male member.

The support can include a clamp and the male member.

The ground stake can be telescopic and be provided with a ground spear.

The support can be provided with a ball joint which enables the shading device to be orientated at variable angles in relation to same.

The support can comprise:
(a) a clamping device having a forked end which is adapted to be fitted to a parallel ledge and another end which is provided with a plurality of receiving sockets, and
(b) a first ball joint member having a ball receiving socket at one end and an insert member at the other end, and
(c) a second ball joint member having an insert for engaging with the handle of the shading device and another with a ball for engagement with the receiving socket of the first ball joint member.

The ball joint of support can enable the shading to pivot with respect to the female member throughout 3600 on a horizontal plane.

The support can include locking means which enable the clamping device to be releasably secured with respect to a ledge, and the shade handle support to be releasably secured with respect to the ball joint.

The support can include a device which is releasably engageable with the handle of a shading device and is adapted for connection to the male member of the support.

### BRIEF DESCRIPTION OF THE DRAWINGS

Aspects of the present invention will now be described with reference to the accompanying drawings in which;

FIG. 1 is a diagrammatic side view of a shading device such as an umbrella supported by a ground stake, and

FIG. 2 is a perspective view of one embodiment of a support for an umbrella according to the present invention, and

FIG. 3 is a side perspective view of a handle engagement device according to the present invention, and

FIG. 4 is a side view of a handle for a shading device providing a female socket according to a further aspect of the invention, and

FIGS. 5, 5a and 5b are side and plan views of a male ball joint member according to a further aspect of the present invention, and

FIGS. 6 and 6a are side and plan views of a female ball joint member according to a further aspect of the present invention, and

FIG. 7 is a side view of a male/female adaptor according to a further aspect of the present invention, and

FIGS. 8 and 8a are side and top views of a spear for a ground stake according to a further aspect of the present invention, and

FIG. 9 is a further view of an assembly between elements of the accessory of the present invention, and

FIG. 10 is a side view of a supporting ground stake for the accessory of the present invention, and

FIG. 11 is a perspective view of an arrangement of the supporting ground stake for the accessory of the present invention, and

FIG. 12 is a side view of a still further arrangement of the ground stake for the accessory of the present invention.

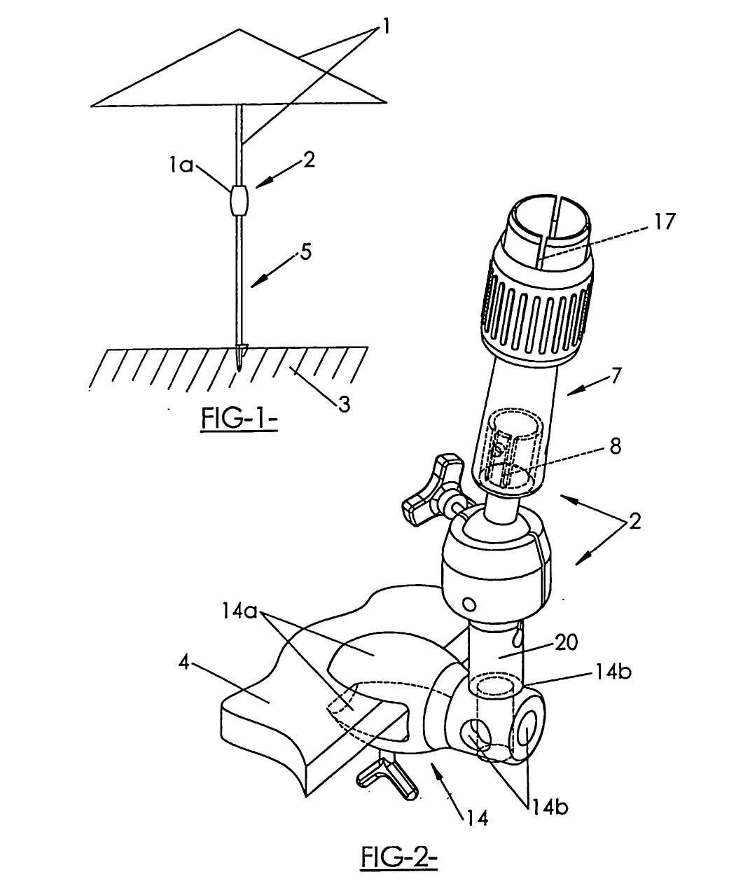

With respect to FIGS. 1 and 2 of the drawings a shading device such as an umbrella generally indicated by arrow 1 and an accessory generally indicated by arrow 2 which provides hands-free support for the umbrella 1.

In two separate arrangements, an accessory 2 supports the umbrella from a ground surface 3 (FIG. 1) or an objects such as a table edge flange, rail or the like 4 (FIG. 2).

In the FIG. 1 arrangement the accessory 2 provides a male and female connection to the handle 1a of an umbrella 1 supported by a ground stake 5 generally indicated by arrow 5

In the FIG. 2 arrangement the accessory 2 provides a male and female attachment for the handle (not shown) of an umbrella and a support which includes a handle grip explained in more detail in the ensuing description.

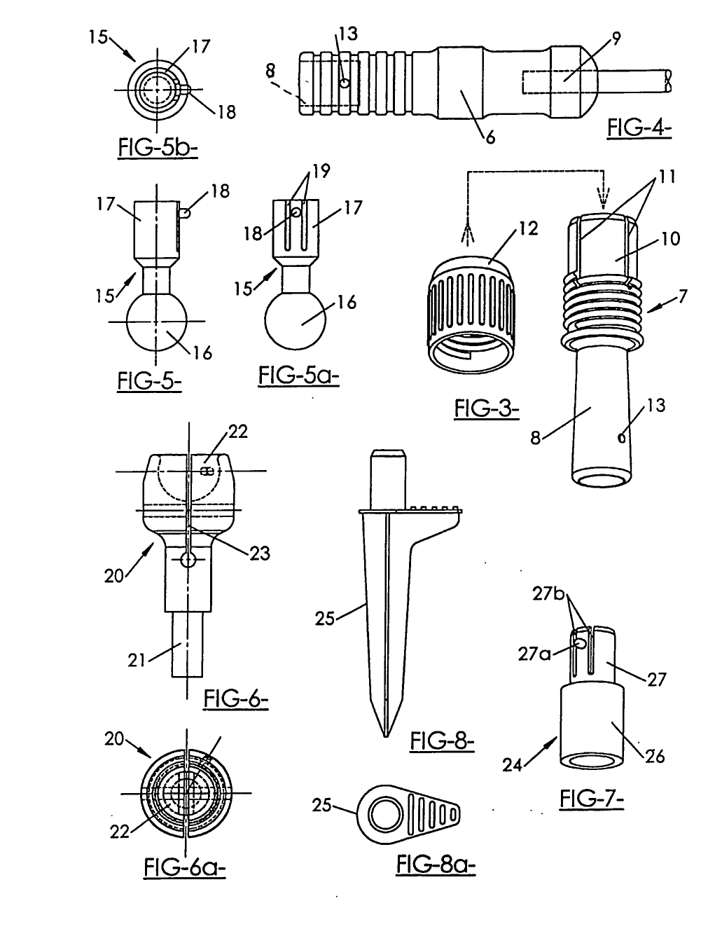

The umbrella 1 can be provided with an especially adapted handle 6 as illustrated by FIG. 4, or alternatively an umbrella handle receiver generally indicated by arrow 7 as illustrated by FIG. 3 can receive and secure a standard umbrella handle.

In both cases the handle 6 or receiver 7 are provided with an internal socket 8.

The adapted handle 6 is a generally elongate cylindrical member including an umbrella shaft receiving socket 9.

The umbrella handle receiver 7 includes an externally threaded socket 10 having wasted portions 11 and an internally threaded collar 12.

The receiver 7 is adapted to receive the handle of a standard umbrella in the socket 10 and the collar 12 is used to tighten the walls of the socket on the umbrella handle.

In both cases the walls of the handle 6 and receiver 7 are provided with a detent receiving apertures 13.

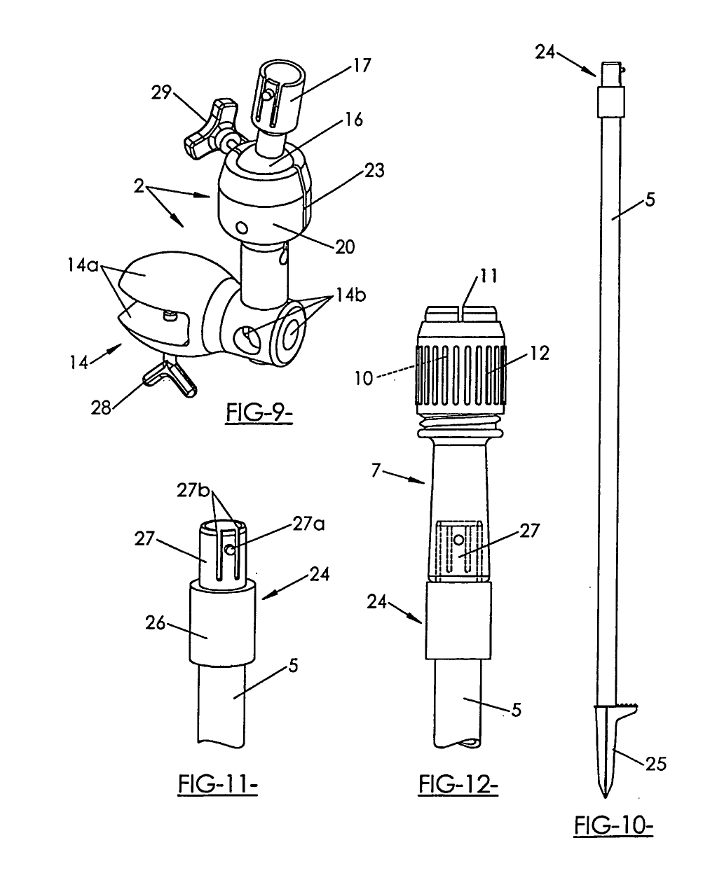

With respect to FIGS. 5 to 6a the elements illustrated provide a ball joint between an umbrella handle 6 or receiver 7 and a clamping device generally indicated by arrow 14 (FIGS. 2 and 9).

A first of the elements generally indicated by arrow 15 comprises a ball 16 and a conjoined socket 17.

The socket 17 is provided with an externally extending pin 18 in a portion of its wall adjacent two wasted wall portions 19.

A second ball joint element generally indicated by arrow 20 illustrated by FIGS. 6 and 6a provides a male fitting 21 and a ball socket 22 for receiving the ball 16 of the adjacently illustrated element 15.

The portion of the element 20 providing the ball socket has opposed slots 23 which enable the ball socket 22 to open to accept the ball 16.

FIGS. 7 to 8a illustrate a male/female adaptor generally indicated by arrow 24 and a ground spear device 25 for fitment to a ground stake (not shown) to provide the ground support arrangement illustrated by FIG. 1 of the drawings.

The male/female adaptor 24 has a socket 26 for fitment to one end of a ground stake and a male element 27 for engagement with the sockets 8 of the umbrella handles. The other end of a ground stake is fitted to the spear 25.

The male element 27 is provided with a pin 27a in a portion of its wall adjacent two wasted wall portions 27b.

The detent mechanisms described enable the locking and unlocking of male and female elements in a simple and affective manner.

Further with reference to FIGS. 2 and 9 of the drawings, the support 2 comprises three elements, a first including a ledge clamping device 14 having forks 14a for engagement with a ledge 4 and a plurality of receiving sockets 14b.

A first ball joint member 20 is provided with a male insert fitting 21, a socket 22 and slots 23.

A second ball joint member is provided with a ball 16, a socket 17 with wasted wall portions 17 and a pin 18.

The assembly of the support 2 of FIGS. 2 and 9 is self-evident from the illustrations and it is noted that the support can be engaged directly with a shading device handle receiver 7 or where a compatible female connection is embodied within the handle of a shading device directly with the handle.

The forks 14a of the clamping device 14 can be secured by swivel screws 28 and the ball joint can be stiffened by thumb screws 29.

FIGS. 10 to 12 of the drawings illustrate various arrangements and adaptations for supporting a shading device using a ground stake 5.

In FIG. 10, the ground stake 5 is provided with a spear 25 and a male/female adaptor 24 as described in relation to FIG. 7 for making one form of connection between ground stake sections.

In FIGS. 11 and 12, the male/female adaptor 24 is inverted and ready to accept the adapted handle of a shading device or the shading device handle receiver 7.

The ground stake 5 can be made from a number of sections which may be single elements or telescopic elements.

It is considered that the present invention provides a useful accessory for the hands-free support of umbrellas and other shading devices enhancing the useability of same at a modest cost.

Aspects of the present invention have been described by way of example only and it will be appreciated that modifications and additions thereto may be made without departing from the scope thereof, as defined in the appended claims.

1. An accessory for facilitating the hands-free support of a shading device, the accessory comprising;
(a) a female member,
(b) a male member attachable to the female member, and
(c) a support, characterised in that the female member is embodied within or attachable to a handle of a shading device and the male member is embodied with or attachable to the support, said male and female members being configured to allow the interchange of the shading device with respect to a first support in the form of a ground stake and a second support in the form of a clamping device:

2. An accessory as claimed in claim 1 wherein the support is a ground stake and includes the male member.

3. An accessory as claimed in claim 1 wherein the support includes a clamp and the male member.

4. An accessory as claimed in claim 2 wherein the ground stake is telescopic and is provided with a ground spear.

5. An accessory as claimed in claim 1 wherein the support is provided with a ball joint which enables the shading device to be orientated at variable angles in relation to same.

6. An accessory as claimed in claim 1 wherein the support comprises:
(a) a clamping device having a forked end which is adapted to be fitted to a parallel ledge and another end which is provided with a plurality of receiving sockets, and
(b) a first ball joint member having a ball receiving socket at one end and an insert member at the other end, and
(c) a second ball joint member having an insert for engaging with the handle of the shading device at one end and at another end a ball for engagement with the receiving socket of the first ball joint member.

7. An accessory as claimed in claim 5 wherein the ball joint of support enables the shading device to pivot with respect to the female member throughout 360° on a horizontal plane.

8. An accessory as claimed in claim 6 including locking means which enable the clamping device to be releasably secured with respect to a ledge, and the shade handle support to be releasably secured with respect to the first ball joint.

9. An accessory as claimed in claim 1 wherein the support includes a device which is releasably engageable with the handle of a shading device and is adapted for connection to the male member of the support.

10. An accessory for supporting an article the accessory comprising:
(a) a clamping device having a forked end which is adapted to be fitted to a parallel ledge and another end which is provided with a plurality of receiving sockets, and
(b) a first ball joint member having a ball receiving socket at one end and an insert member at an opposite end for insertion into a receiving socket of the clamping device, and
(c) a second ball joint member having an upstand for engaging with a complementary socket of an article to be supported by the accessory at one end and a ball for engagement with the receiving socket of the first ball joint member at an opposite end.

11. An accessory as claimed in claim 10 wherein the first and second ball joint members enable an article supported by the accessory to pivot throughout 360° on a horizontal plane.

12. An accessory as claimed in claim 10 including locking means which enable the clamping device to be releasably secured with respect to a ledge, and a supported article to be releasably secured with respect to the first ball joint member.

13. An accessory as claimed in claim 10 wherein the support includes a device which is releasably engageable with the handle of a shading device.
